(19) United States
(12) Patent Application Publication
(10) Pub. No.: US 2002/0093145 A1
(43) Pub. Date: Jul. 18, 2002

(54) Gasket, in particular for fittings such as doors, windows and the like

(76) Inventors: Alfonso Caldiroli, Legnano (IT); Paolo Cittadini, Luvinate (IT)

Correspondence Address: Robert F. I. Conte, LEE, MANN, SMITH, McWILLIAMS, SWEENEY & OHLSON, P.O. Box 2786, Chicago, IL, 60690-2786, US

(21) Appl. No.: 10/020,289

(22) Filed: Dec. 12, 2001

(30) Foreign Application Priority Data
Jan. 12, 2001 (IT) MI2001A000045

(51) Int. Cl. F16J 15/53

(52) U.S. Cl. 277/629

(57) ABSTRACT

A gasket for fittings comprises: a sealing body (2) able to be associated with a movable part (3a) of a fitting and able to be actuated between an open and a closed position; a primary return element (4), connected to the movable part (3a) of the fitting (3) and active on the sealing body (2) to actuate it to the open position; and a secondary return element (5), connected to the fixed part (3b) of the fitting (3) and active on the sealing body (2) to actuate it to the closed position.

### FIELD AND BACKGROUND OF THE INVENTION

The present invention relates to a gasket, in particular for fittings such as doors, windows and the like, comprising at least one sealing body (2) able to be operatively associated with a movable part (3a) of a fitting and to be actuated between at least one open position, in which it allows a passage of fluid between said moving part (3a) of the fitting and a corresponding fixed part (3b) co-operating with said movable part (3a), and at least one closed position, in which said fluid passage is substantially prevented.

As is well known, in very many applications (ranging from the construction industry to the manufacture of vehicles for transporting persons) particular structures are used, commonly known as “fittings”; depending on the application, fittings can be constituted by doors or windows (in the construction industry) as well as by variously secured doors of motor vehicles (for instance, hinged doors, sliding doors, swivelling doors or other types of fittings).

In any case, aside from the possible applications in which such fittings may be found, note that generally such constructive elements are constituted by a movable closure element, which is secured to a second component that constitutes its supporting frame; obviously, said second component is fixed, whilst the fitting is operated by actuating the movable closure fitting.

In the great majority of applications of practical interest, it is necessary to guarantee an adequate isolation of the two spaces separated by the door itself: for instance, an entrance door of a dwelling must be able to allow access from inside the dwelling itself, but once closed it must not allow air, dust or water coming from the outside; a nearly identical case can be made for the doors of vehicles used for transporting persons, where the movable surfaces (windowpanes and edges of the doors or cargo doors) must provide a perfect tightness against external atmospheric agents.

Delving in greater detail it should be noted that, although the closure elements of large fittings (for instance, a door, or a window, or a sliding wing of a piece of furniture etceteras) have a surface that occludes nearly the entire passage, along the edge of this surface there is always a very thin gap through which external atmospheric agents are free to circulate. Obviously, the undesired passage of air through said thin gaps entails different problems, among which for instance one can mention the loss of heat from the interior, the onset of annoying draughts, the infiltration of humidity or particles of dust (which are detrimental to the quality of the interior environment) or even to the occurrence of annoying whistles and other noises.

The prior art in this field provides different solutions, which are aimed to prevent the passage of air through the aforesaid gap.

Typically, the prior art provides the use of appropriate gasket elements interposed between the fixed part and the movable part of the fitting; said gasket elements are practically positioned in such a way as to abut between the fixed and the movable part of the fitting, so as physically to prevent the passage of air and/or other types of matter (water, dust, etceteras).

In particular, a type of widely used gasket elements, especially when coupled to doors and/or windows of buildings, provides the presence of an abutting body, shaped in such a way as to occlude almost entirely the gap between closure element and fixed part of the fitting; from said abutting body projects an elastic portion, generally constituted by a lip made of rubbery material or by a very thick barrier of bristles, which is deformed, practically by crushing, under the movable element of the fitting (when the latter is brought to the closed position), thereby completing the occlusion of the gap.

This known prior art has, as can be readily perceived, a series of drawbacks: the very nature of the elastic portion greatly limits its working life. As a result of the repeated stresses the elastic portion undergoes against the edge of the movable element of the fitting (which usually has a configuration provided with a sharp edge), the elastic portion breaks or frays, thereby losing its insulating capability.

To overcome this operative drawback, which is essentially due to the intrinsically yielding nature of the elastic portion, a different type of gasket has been obtained.

This type of gasket provides the presence of a permanent magnet integral with the movable part of the fitting and oriented towards the gap; to said permanent magnet is functionally coupled a ferromagnetic element (which can be a permanent magnet itself), which is inserted in a recess of the fixed part of the fitting. More in particular, said ferromagnetic element is fastened in the recess in such a way as to be able to slide vertically therein (so as to be able to approach or move away from the lower edge of the movable part of the fitting); further provided are suitable return means (typically, springs or rubber bands) acting on the ferromagnetic element to make it withdraw into the recess when the permanent magnet integral with the movable part of the fitting is moved away.

When the movable element of the fitting is brought into the closed position, the permanent magnet integral therewith attracts towards itself the ferromagnetic element, which is made to slide in the recess by magnetic attraction, thereby shutting the gap; vice versa, when the fitting is open, the permanent magnet is moved away and the elastic return means cause the ferromagnetic element to return into the recess.

Although it does have an advantage relative to the gasket elements described above, in terms of the wear resistance of the parts that provide insulation from external atmospheric agents, unfortunately this prior art device also has a series of drawbacks.

The accumulation of dust, and more in general of solid debris, in the recess (which is usually located at ground level) prevents the correct withdrawal of the second ferromagnetic element; in this way, it is practically impossible to occlude the fitting completely, since said ferromagnetic element interferes with the movable part of the fitting itself specifically in correspondence with the closed position.

The aforementioned technical drawback is particularly aggravated if the conditions of use of such a device are those typical of the thresholds obtained at the entrance doors of dwellings: in such cases the gasket, usually installed at ground level, is subject to being trod by persons (or also by animals) entering or leaving the dwelling. In such operating conditions, it is evident that the stresses imposed by the crushing (even if involuntary) of the gasket itself by those who tread thereon and above all the great quantity of material (dirt, dust, pebbles and others) which is carried by the soles of the shoes and then falls into the recess obtained in the floor leads very quickly to the failure of this type of gasket.

### SUMMARY OF THE INVENTION

In the light of the above, a fundamental aim of the present invention is to obtain a gasket, in particular for fittings such as doors, windows and the like that is able substantially to overcome all the technical drawbacks briefly described above.

In particular, the technical aim of the present invention is to devise a gasket that is able to offer a high sealing ability against atmospheric agents, both in the case of air flows and when liquid or solid particles (atmospheric humidity and/or particulate) are present.

Yet another aim of the present invention is to obtain a gasket that is practically free from durability problems, in which in particular the components that provide the actual sealing action have a practically unlimited working life.

A further aim of the invention is to devise a gasket whose operating mechanism is free from possible malfunctions and which consequently cannot cause an imperfect closure of the fitting itself.

Lastly, an additional aim of the present invention is to devise a gasket that allows to obtain the advantages listed above and which at the same time is characterised by its having low costs of manufacture.

These and other technical aims, according to the contents of the description that follow, are essentially reached by a gasket, in particular for fittings such as doors, windows and the like comprising at least one primary return element (4), connected at least to the movable part (3a) or to the fixed part (3b) of the fitting (3) and operatively active on the sealing body (2) to actuate it at least in said open position; and at least one secondary return element (5), connected to the fixed part (3b) or to the movable part (3a) of the fitting (3) and operatively active on the sealing body (2) to actuate it at least in said closed position.

### BRIEF DESCRIPTION OF THE DRAWINGS

Further features and advantages shall become more readily apparent from the detailed description of some preferred, but not exclusive embodiments of a gasket in accordance with the invention.

This description shall be provided hereafter with reference to the accompanying drawings, provided purely by way of non limiting indication, in which:

FIG. 1 is a partially sectioned lateral view of the gasket according to the present invention in a first operative configuration;

FIG. 2 is a partially sectioned lateral view of the gasket according to the present invention in a second operative configuration;

FIG. 3 is a partially sectioned view of a detail of the gasket of FIG. 1;

FIG. 4 is a partially sectioned view of a detail of an embodiment variation of the gasket of FIG. 1; and

FIG. 5 is a partially sectioned view of a detail of an embodiment variation of the gasket of FIG. 1.

### DESCRIPTION OF THE PREFERRED EMBODIMENTS

With reference to the accompanying drawings, the number 1 globally indicates a gasket in accordance with the present invention.

It firstly comprises a sealing body 2, which is able to be operatively associated with a movable part 3a of a fitting 3.

The sealing body 2 can be reversibly actuated between an open position, in which it allows a passage of fluid between the movable part 3a of the fitting and a corresponding fixed part 3b of the fitting 3 cooperating with the movable part 3a, and a closed position, in which the aforesaid passage of fluid is substantially prevented.

In other words, the sealing body 2 moves between the fixed part 3b and the movable part 3a of the fitting: depending on whether the fitting in question is in the open or in the closed position, the sealing body 2 operates in such a way as to position itself in the gap formed by the two parts of the fitting.

At this point it should be noted that the fixed part 3b of the fitting can be constituted, depending on the case, by the jamb of a door or of a window or by the frame that surrounds them.

In particular, an advantageous application of the present invention provides for the case in which the fixed part 3b of the fitting 3 comprises or is constituted by a floor portion or by a shaped profile integral with the floor; in this case, the gasket 1 is applied to a threshold, and it is operatively active between the floor (or the profile integral therewith) and the lower portion of the door (or window).

Opportunely, the gasket 1 according to the present invention comprises a primary return element 4; said primary return element 4 can advantageously be connected to the movable part 3a or to the fixed part 3b of the fitting 3 (depending on the needs of the moment) and it is operatively active on the sealing body 2 to actuate it in the open position.

The present invention also comprises a secondary return element 5, connected to the fixed part 3b or to the movable part 3a of the fitting 3 (obviously, depending on whether the primary return element is connected to the complementary part of said fitting) and operatively active on the sealing body 2 to actuate it in the closed position.

Advantageously, the relative disposition of the primary and secondary return elements 4 and 5 with respect to the sealing body 2 is such as to allow its actuation in the open and/or closed positions in coordination with the opening and/or closing of the fitting 3 itself.

In other words, the present invention provides for a constructive architecture that minimises possible mechanical interference between the gasket and the fitting (in particular during the actuation thereof), in such a way as to allow the opening and closing of the door or of the window whereto it is connected.

Thanks to the disposition of the primary and secondary return elements 4 and 5, but above all to the combination of the actions exerted thereby on the sealing body 2, when the fitting is opened, the sealing body 2 is immediately brought to the open position, thus allowing the door (or window) to rotate on its hinges or to slide along its guides. Vice versa, when the movable part 3a and the fixed part 3b of the fitting 3 are brought closer together (i.e. when the door or the window in question is closed), the combined action of the return elements brings the sealing body 2 to the closed position; in accordance with the present invention, the attainment of the closed position, just like the attainment of the open position, is brought about by an appropriate combination of the forces acting between the sealing body 2 and the return elements 4 and 5; as shall be described in greater detail farther on in the present description, the quantitative and/or qualitative combination of the forces acting on the sealing body can advantageously be calibrated according to operative requirements.

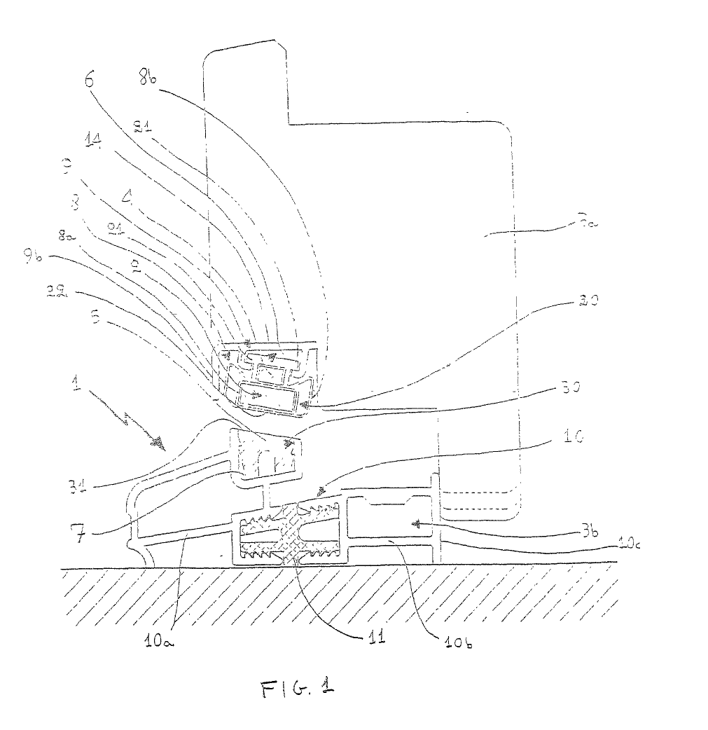

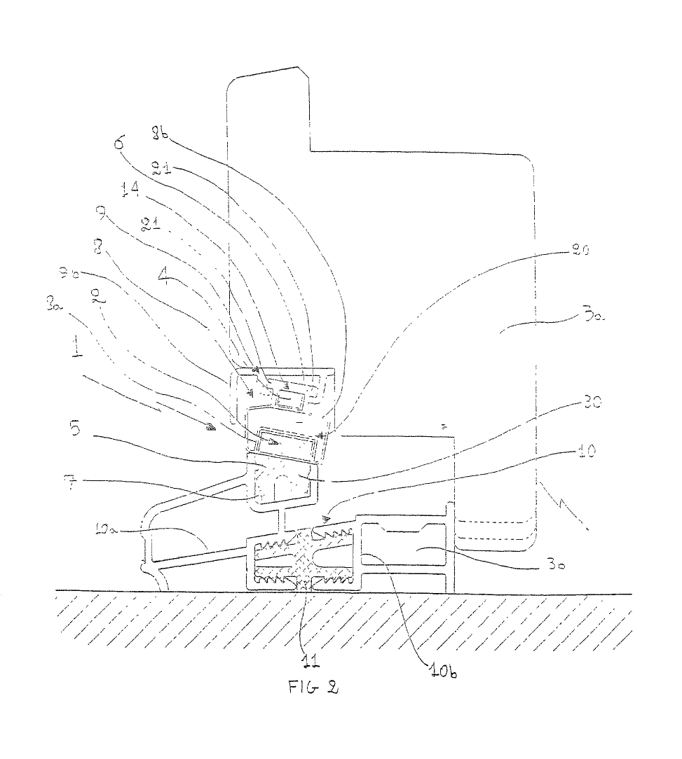

In the particular embodiment of the present invention, shown in FIGS. 1 and 2, the gasket 1 has the primary return element 4 connected to the movable part 3a of the fitting 3 (and active on the sealing body 2 to actuate it in the open position), whilst the secondary return element 5 is connected to the fixed part 3b of the fitting 3 and it is active on the sealing body 2 to actuate it in the closed position.

From the construction profile, it should be noted that the primary return element 4, the sealing body 2 and the secondary return element 5 can comprise one or more magnetically active or passive portion.

In greater detail, it should be noted that the magnetically passive portions are in practice constituted by ferromagnetic materials, whilst the magnetically active portions are constituted by magnetic or magnetised materials (preferably permanent magnets).

Conveniently, thanks to the opportune choice of the size of the permanent magnets and/or to their performance in terms of intensity of the generated magnetic field (i.e. by selecting materials having predetermined permeability and/or magnetic susceptibility), it is possible to determine the size of the interacting forces that are generated between said three components (the sealing body 2 and the primary and secondary return elements 4 and 5) when they are in the configurations relating to the open or closed positions.

In particular, the difference in generated magnetic forces can opportunely be obtained by making the aforesaid components with a material (known as plastoferrite) composed of a mixture of rubbery inert substance with magnetic particulate (for instance ferrite powder or others): in this case, the intensity of the generated magnetic fields is proportional to the relative percentage of magnetic particulate with respect to the inert rubbery substance (naturally, in addition to the size of the component itself and the type of particulate in use).

Advantageously, the present invention contemplates a wide range of possible combinations for the nature of the sealing body 2 and of the primary and/or secondary return elements 4, 5. For instance, it is possible for the sealing body 2 alone to be a permanent magnet (thereby being the only one, among the three components in question, to have a magnetically active portion), whilst the return elements 4 and 5 may be constituted exclusively by non magnetised ferromagnetic material; in this way the difference between the magnetic forces generated will depend on the diversity of the sizes and of the magnetic properties of the bodies subjected to magnetic interaction (i.e. of the primary and secondary return elements 4 and 5) with the body generated by the sealing body 2.

Alternatively, only the return elements 4 and 5 may be permanent magnets, whilst the sealing body 2 has exclusively the so-called magnetically passive portion.

The operation of the gasket 1 according to the present invention can be summarised as follows: when the fitting 3 is open, the sealing body is at a greater distance with respect to the secondary return element 5, and is thus attracted by the magnetic force generating between it and the primary return element 4, thereby moving into the open position (essentially, the sealing body 2 is next to the primary return element 4).

When the movable part 3a is approached to the fixed part 3b (i.e. when the fitting is closed), the sealing body 2 is also subjected to the magnetic interaction of the secondary return element 5; at a certain time (corresponding to a determined relative positioning of the movable part 3a and of the fixed part 3b of the fitting 3), the force exerted by the secondary return element 5 exceeds the force exerted by the primary return element 4 and therefore the sealing body 2 moves next to the secondary return element 5, thereby achieving the configuration required by the closed position.

In accordance with the present invention, it is also possible appropriately to orient the magnetic dipoles defined by the permanent magnets along planes that are opportunely angled relative to the direction of approach of the two parts of the fitting 3, in such a way as to choose the quality of the magnetic interactions (attractive or repulsive) and their succession so as to determine any actuation sequence.

For instance (see FIG. 3), assuming that the sealing body 2 and both return elements 4 and 5 are permanently magnetised and have alternating magnetic poles along the aforesaid direction of approach, it is readily apparent that the sealing body 2 (held near the primary return element 4 in the open position when the fitting is open), progressively approaching the space subject to the magnetic field generated by the secondary return element 5 is first repelled thereby, and then attracted; in this way, a sort of “delay” in the setting of the sealing body 2 into the closed position is determined, which delay guarantees the perfect correspondence of the mutually facing surfaces of the sealing body 2 and of the secondary return element 5.

In practice, by dividing longitudinally into one or more pairs of magnetically alternating strips the magnets operating in the gasket 1 according to the present invention, a high closure precision is advantageously reached.

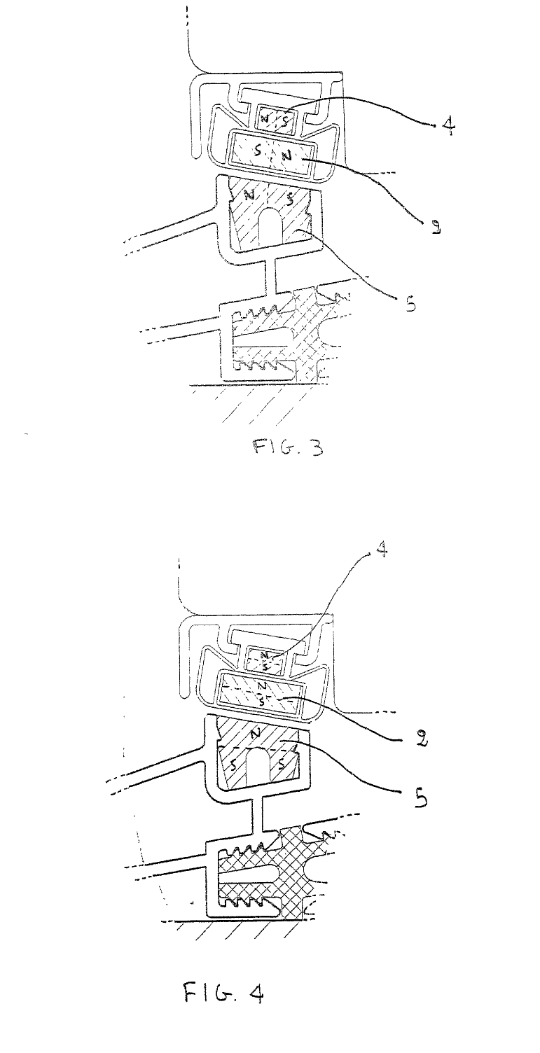

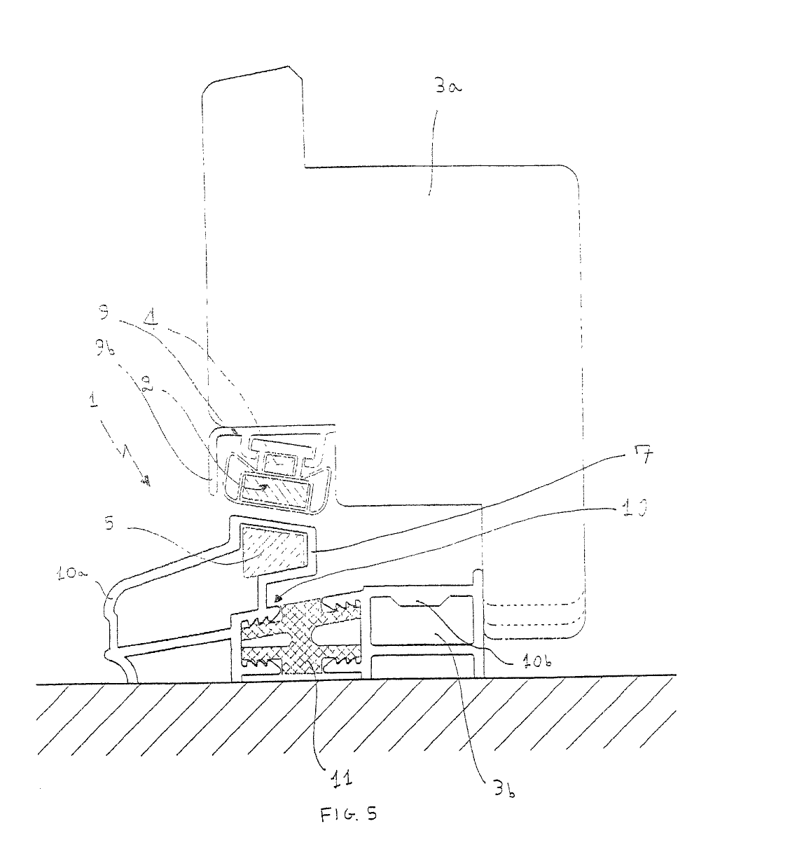

Obviously, if the required constructive/functional characteristics are not particularly advanced in terms of the closure precision of the gasket 1, it is possible to use magnets with their poles alternating orthogonally to the direction of approach (as shown for instance in FIG. 4); in this case, when the sealing body 2 approaches the portion of space that is permeated by the magnetic field of the secondary return element 5 an attractive force is progressively generated, which force moves the sealing body 2 itself only when it is greater than the attractive force existing between the sealing body 2 and the primary return element 4.

Essentially, in all possible embodiments falling within the concept of the present invention the sealing body 2 comprises a magnetically active portion and/or a magnetically passive portion, and it is actuated into the open position by a primary magnetic force generating from the interaction between its own magnetically active and/or passive portion and at least the magnetically passive and/or active portion of the primary return element 4; similarly, the sealing body 2 is actuated into the closed position by a secondary magnetic force generating from the interaction between its own magnetically active and/or passive portion and the corresponding magnetically passive and/or active portion of the secondary return element 5.

In order to obtain a very high ability to resist air, water or dust infiltrations, the gasket 1 according to the present invention is provided with a connecting body 8, which is operatively interposed between the sealing body 2 and the primary return element 4 (or, depending on the case, the secondary return element 5) to actuate the sealing body 2 from the closed to the open position.

In particular, said connecting body 8 comprises a housing portion 8a at least partially counter-shaped relative to the sealing body 8 (and destined to receive it under operative conditions), whereto is connected a deformable portion 8b. The deformable portion 8b is also connected to the fixed part 3b (or to the movable part 3a, as the case may be) of the fitting 3.

Advantageously, the deformable portion 8b is made of a given material and has an appropriate shape, so that it is in a substantially and elastically contracted configuration when the sealing body 2 is in the open position, whilst it is in a substantially and elastically extended configuration when the sealing body is in the closed position.

The housing portion 8a of the connecting body 8 has, in the preferential embodiment shown herein, a substantially “C” shaped cross section (more generally, said connecting body is shaped according to a tubular-rectangle, or in the manner of a sheath). Inside said “C” or in any case of said sheath, the sealing body 2 is housed, whereas the outermost part of the “C” (or, more in general, the outermost part of the sheath) is constituted by a series of thin walls, preferably made of elastomeric material, which can deform as a result of the magnetic interaction between the sealing body 2 and the return elements 4 and 5.

It should be observed that the connecting body, through its deformable portion 8b, contributes to create the perfect seal of the gasket, since it essentially behaves as a physical barrier to the passage of air, water and anything else that may move through the fitting when the latter is shut; for this purpose, any geometric configuration of the deformable portion 8b can be selected, for instance an appropriate deformable portion 8b shaped as a traditional “bellows” or other convenient shape can be provided.

To clarify now the physical structure of the gasket 1 according to the present invention, it should be noted that it is in fact constituted by two physically separate half-parts: a first active half-part, also known as primary gasket 20 and a second passive half-part also known as secondary gasket 30.

Within the scope of the present invention, it should be noted that the active half-part physically and mechanically achieves the sealing of the fitting against air, water and/or dust infiltrations, whilst the passive half-part serves as a closure abutment for the active half-part.

Delving in greater constructive detail, it should be noted that the active half-part, or primary gasket 20, substantially comprises the primary return element 4, the sealing body 2 and the connecting body 8. As the accompanying figure shows, it comprises three portions: an anchoring portion, destined to be engaged to the movable part 3a of the fitting 3, a connecting portion connected at an end to the anchoring portion, and a head portion connected to the connecting portion at the opposite side from the anchoring portion.

More in detail, it should be observed that the anchoring portion comprises the primary return element 4 and also a support body 14; advantageously, said support body 14 has a housing seat destined to receive the primary return element 4 (said housing seat is substantially counter-shaped relative to the primary return element 4, in order to obtain the utmost stability of connection between the pieces in question). Moreover, the housing seat has abutment expansions 21, which are appropriately shaped to fasten the anchoring portion to the movable part 3a of the fitting 3 (directly thereto or to a support frame; the latter shall be described in detail farther on in the present description).

Advantageously, the connecting portion is obtained integrally to the anchoring portion, and in practice it develops starting therefrom into a direction that goes towards the fixed part 3b of the fitting 3. Note that the connecting portion practically comprises the deformable portion 8b of the connecting body 8. In regard to the head portion, it should be now noted that it comprises substantially the sealing body 2 and the housing portion 8a of the connecting body 8; in the embodiment shown in the figures, said housing seat 8a is counter-shaped relative to the sealing body. It should also be noted that said head portion is advantageously provided with a primary abutment portion 22, which is substantially planar and corresponds to the face of the sealing body 2 that serves as an abutment on the secondary return element 5. In practice, said primary abutment surface 22 is delimited by a soft, preferably elastomeric material, so that it can be elastically compressed between the sealing body 2 and the secondary return element 5 (preventing any infiltrations of air and any other elements which may traverse the cavities formed by surface micro-irregularities).

In accordance with the present invention, the anchoring portion, the connecting portion and the head portion are made of the same soft and/or elastomeric material; moreover said three components are advantageously made in a single piece, for instance by means of co-extrusion through a pre-defined template (said co-extrusion is performed together with the primary return element 4 and the sealing body 2, thereby significantly reducing manufacturing times whilst also guaranteeing a very high structural coherence of the primary gasket 20 itself).

In regard instead to the secondary gasket 30, it should be observed that its structure is much simpler than the primary structure 20: it practically comprises only the secondary return element 5.

More specifically, the secondary gasket 30 has a secondary abutment surface 31, substantially corresponding to the primary abutment surface 22 and destined to abut against it when the sealing body 2 reaches the closed position. Advantageously, if the gasket 1 according to the present invention is to be mounted in correspondence with the floor, the secondary gasket 30 will be made of materials with a high degree of hardness, in order to resist wear from treading.

It is in any case possible, should specific needs require it and make it possible, to provide the secondary gasket 30 with a soft cover, for instance the same elastomeric material used in the primary gasket 20; this cover (not shown in the figures) is conveniently positioned in correspondence with the secondary abutment surface 31 in order further to improve the tightness of the gasket itself.

Within the scope of the present invention falls, advantageously, also a fitting provided with the gasket 1 described above.

More specifically, said fitting (for doors, windows and the like) comprises a primary housing seat 6, which is integrally connected to the movable part 3a of the fitting 3 and destined to receive the primary return element 4.

At the same time, the fitting in question further comprises a secondary housing seat 7, which is integrally connected to the fixed part 3b of the fitting 3 and is destined to receive the secondary return element 5. In accordance with the previous descriptions, the fixed part 3b of the fitting can be constituted by one or more sides of a fixed frame (integral, for instance, with a wall), or it may be the floor portion located in proximity to the movable part 3a of the fitting 3 when the latter in the “closed” configuration.

Advantageously, if the fixed part 3b is in fact a floor portion, the secondary housing seat 7 is practically constituted by a recess obtained at least partially in the floor portion itself. Obviously said recess will house completely or partially, depending on operative requirements, the sealing body 2 and/or the secondary return element 5, in such a way as not to constitute a hindrance for users walking through the space where the fitting is positioned.

The fitting in accordance with the present invention further comprises a primary support frame 9, which is integrally connected to the movable part 3a of the fitting 3.

Advantageously, said primary support frame 9 defines the primary housing seat 6 destined to receive the primary return element 4; in addition, the primary support frame 9 comprises a protection frame 9b substantially oriented towards the external environment and connected to the primary housing seat 6 (said protection surface 9b acts as a shield against shocks and/or impacts against the primary return element 4, and as an aesthetic element).

In accordance with the present invention, the subject fitting can comprise a secondary support frame 10. Said secondary support frame 10 is integrally connected to the fixed part 3b of the fitting 3.

Advantageously, said connection can be obtained directly with the corresponding floor portion positioned at ground level and in proximity to the movable part 3a of the fitting 3, in such a way as to offer a portion that users can tread upon, thereby engaging the opening whereon the fitting is mounted without ruining the gasket 1 or tripping in the recess.

Delving deeper in detail, one notes from FIGS. 1 and 2 that the secondary support frame 10 comprises an outer portion 10a (destined to be oriented at least partially towards the external environment under operating conditions) whereto an inner portion 10b is structurally and functionally connected.

The inner portion 10b has an abutment portion 10c, which is destined to be engaged at least partially by the movable part 3a of the fitting 3 (typically, by the lower part of the surface of a door—see FIG. 2) when the sealing body 2 is in the closed position.

In accordance with the present invention, the secondary housing seat 7 is integrally obtained in the outer portion 10a of the secondary support frame 10, in an appropriately oriented geometric configuration. In particular, the secondary housing seat 7 is positioned in such a way that the secondary return element 5, which is contained therein, has a surface that is oriented outwards and inclined by a certain angle; in this way, adherence to the sealing body 2 is optimised when the sealing body 2, attracted towards the secondary return element 5, abuts against it.

Should specific requirements so demand, the secondary return element 5 can be contained inside a coating sheath made of a different material from the one whereof the secondary support frame 10 is made (for instance, a sheath made of plastic or elastomeric material), in order to assure a substantial protection against treading and/or against external atmospheric agents.

Advantageously the secondary return element 5 can also be completely contained inside the outer portion 10a of the secondary support frame 10, and more specifically in a part of the outer portion 10a duly shaped and positioned in proximity to the sealing body 2 (see FIG. 5). In the embodiment shown in FIG. 5, the secondary return element is completely protected from treading and from external atmospheric agents, but it is nonetheless able to activate the appropriate electromagnetic interactions with the sealing body 2; the protective function served by the outer portion 10a is considerably improved by the nature of the material whereof the outer portion 10a (which typically can be an extruded aluminium element).

To prevent heat flows from and/or towards the exterior environment, the secondary support frame 9 comprises a heat cut-off element 11, which is operatively interposed between the inner portion 10b and the outer portion 10a.

Consistently with the above description, the present invention further relates to a threshold (for instance, a door or a window of a building, in particular for entrance spaces in buildings, or else a door or a cargo door of a vehicles), comprising a fitting having one or more characteristics like the ones described above; naturally, the present invention also relates to a fitting, adapted to the aforesaid threshold, comprising at least one gasket 1 having one or more of the structural and/or functional characteristics discussed above. According to a particular form of application of the present invention, said threshold comprises, at least in correspondence with a side defined by or operatively associated with a floor portion, a gasket having one or more characteristics of the present invention.

The invention achieves important advantages.

In the first place, it should be noted that the particular relative disposition of the ferromagnetic bodies allows advantageously to exploit the interactions that are created between them, in order to obtain, depending on whether the movable element is in proximity to the closed position or not, the optimal operation of the fitting itself without causing interference or blockage. Moreover, it is readily apparent that the present invention is devised in such a way as to be free of any areas where solid debris may accumulate and thereby blocking the movements of the various parts of the gasket itself; in other words, the operation of the gasket in accordance with the present invention is guaranteed also in the presence of harsh environmental conditions and it practically remains in top material condition for a practically unlimited time.

Furthermore, the present invention achieves a considerable technical advantage in terms of efficiency in maintaining tightness, since the exploitation of the magnetic forces that govern the positioning of the gasket in the two different operative conditions can be calibrated, in terms of magnetic forces and hence of pressure between the surfaces in contact, in the way best suited to guarantee the required impermeability, even in case of fittings having particularly large size.

It should also be noted that the present gasket has a very flexible constructive architecture, adaptable to a very wide range of practical situations; moreover, the absence of particular kinematic mechanisms to obtain the actuation of the movable parts of the fitting is advantageously reflected on lower costs of production (as well as on reliability).

Lastly, it should be appreciated that the gasket 1, used to achieve tightness on a threshold (in the particular illustrated configuration, in which the secondary gasket 30 is constituted only by the secondary return element 5, which in turn is made of suitably resistant and hard material) is very efficient, durable and practically insensitive to wear and treading.

1. Gasket for fitting such as doors, windows and the like, said gasket (1) comprising:
at least one sealing body (2) able to be operatively associated with a movable part (3a) of a fitting and to be actuated between at least one open position, in which it allows a passage of fluid between said moving part (3a) of the fitting and a corresponding fixed part (3b) co-operating with said movable part (3a), and at least one closed position, in which said fluid passage is substantially prevented;
wherein said gasket further comprises:
at least one primary return element (4), connected at least to the movable part (3a) or to the fixed part (3b) of the fitting (3) and operatively active on the sealing body (2) to actuate it at least in said open position; and
at least one secondary return element (5), connected to the fixed part (3b) or to the movable part (3a) of the fitting (3) and operatively active on the sealing body (2) to actuate it at least in said closed position.

2. Gasket as claimed in claim 1, wherein the primary return element (4) is connected to the movable part (3a) of the fitting (3) and is active on the sealing body (2) to actuate it in the open position, and wherein the secondary return element (5) is connected to the fixed part (3b) of the fitting (3) and is active on the sealing body (2) to actuate it in the closed position.

3. Gasket as claimed in claim 1, wherein the primary return element (4) and/or the sealing body (2) and/or the secondary return element (5) comprise at least one magnetically passive portion made of ferromagnetic material.

4. Gasket as claimed in claim 3, wherein the primary return element (4) and/or the sealing body (2) and/or the secondary return element (5) comprise a magnetically active portion, destined to generate forces of magnetic nature in co-operation at least with said magnetically passive portions.

5. Gasket as claimed in claim 4, wherein said magnetically passive portions are made of ferromagnetic materials, the magnetically active portions being constituted by magnetic or magnetised materials, preferably permanent magnets.

6. Gasket as claimed in claim 1, wherein the sealing body (2) comprises a magnetically active and/or a magnetically passive portion and is actuated in the open position by a primary magnetic force generating from the interaction between its own magnetically active and/or passive portion and at least the magnetically passive and/or active portion of the primary return element (4), the sealing body (2) being also actuated in the closed position by a secondary magnetic force generating from the interaction between its magnetically active and/or passive portion and the magnetically passive and/or active portion of the secondary return element (5).

7. Gasket as claimed in claim 1, wherein the primary and secondary return elements (4, 5) are permanent magnets having their magnetic poles alternating along a direction of approach defined by the direction of relative motion between the fixed part (3b) and the movable part (3a) of the fitting (3).

8. Gasket as claimed in claim 1, wherein the primary and secondary return elements (4, 5) are permanent magnets having their magnetic poles alternating orthogonally to said direction of approach.

9. Gasket as claimed in claim 1, further comprising a connecting body (8) operatively interposed between the sealing body (2) and the primary return element (4) or the secondary return element (5) to actuate the sealing body (2) from the closed position to the open position, said connecting body (8) being interposed between the fixed part (3b) and the movable part (3a) of the fitting (3) to prevent a passage of fluid.

10. Gasket as claimed in claim 9, wherein said connecting body (8) is operatively interposed between the sealing body (2) and the primary return element (4) and comprises:
a housing portion (8a) at least partially counter-shaped relative to the sealing body (2) and destined to receive it in operative conditions; and
a deformable portion (8b) connected to said housing portion (8a) and to the movable part (3a) of the fitting (3), said deformable portion (8b) being substantially and elastically contracted when the sealing body (2) is in the open position and being substantially and elastically extended when the sealing body (2) is in the closed position.

11. Gasket as claimed in claim 1, comprising at least one primary gasket (20) and one secondary gasket (30), said primary and secondary gaskets (20, 30) being physically separate parts and mutually co-operating at least in the closed position of the gasket (1).

12. Primary gasket (20), of the type in accordance with claim 11 comprising:
an anchoring portion destined to engage the movable part (3a) of the fitting (3) and including a primary return element (4);
a connecting portion connected to said anchoring portion and comprising a connecting body (8); and
a head portion connected to the connecting portion from the opposite side relative to the anchoring portion and comprising a sealing body (2).

13. Primary gasket (20) as claimed in claim 12, wherein the anchoring portion comprises:
a support body (14) having a housing seat destined to receive the primary return element (4), said housing seat being preferably counter-shaped relative to the primary return element (4); and
a predetermined number of abutment expansions (21) connected to said housing seat and shaped in such a way as to fasten the anchoring portion to the movable part (3a) of the fitting (3).

14. Primary gasket (20) as claimed in claim 12, wherein the connecting portion is obtained integrally to the anchoring portion and develops starting therefrom towards the fixed part (3b) of the fitting (3), the connecting portion comprising at least the deformable portion (8b) of the connecting body (8).

15. Primary gasket (20) as claimed in claim 12, wherein the head portion comprises the sealing body (2) and the housing portion (8a) of the connecting body (8), the housing seat (8a) being preferably counter-shaped relative to the sealing body (2).

16. Primary gasket (20) as claimed in claim 15, wherein the head portion comprises a primary abutment surface (22) destined to abut on the secondary return element (5) in the closed position of the gasket (1), said primary abutment surface (22) being preferably planar and yet more preferably being delimited by a soft, preferably elastomeric material.

17. Primary gasket (20) as claimed in claim 12, wherein the anchoring portion, the connecting portion and the head portion are obtained in a single piece, preferably by means of co-extrusion with at least the holding body (2) and/or the primary return element (4), and wherein the anchoring portion, the connecting portion and the head portion are preferably made of the same soft and/or elastomeric material as the primary abutment surface (22).

18. Secondary gasket (30) as claimed in claim 11, comprising the secondary return element (5) and having a secondary abutment surface (31) that substantially corresponds to the primary abutment surface (22), said secondary abutment surface (31) being destined to receive the abutting primary abutment (22) when the sealing body (2) is in the closed position.

19. Fitting for doors, windows and the like, comprising at least one gasket as claimed in claim 1, further comprising a primary housing seat (6) integrally connected to the movable part (3a) of the fitting (3) and destined to receive the primary return element (4).

20. Fitting as claimed in claim 19, further comprising a secondary housing seat (7) integrally connected to the fixed part (3b) of the fitting (3) and destined to receive the secondary return element (5), the fixed part (3b) of the fitting (3) comprising a frame extending at least partially around the perimeter of the movable part (3a) of the fitting (3) and preferably further comprising a corresponding floor portion positioned at the ground level and in proximity to the movable part (3a) of the fitting (3).

21. Fitting as claimed in claim 20, wherein said secondary housing seat (7) comprises a recess obtained at least partially in said floor portion positioned at the ground level and in proximity to the movable part (3a) of the fitting (3).

22. Fitting as claimed in claim 19, further comprising a primary support frame (9) integrally connected to the movable part (3a) of the fitting (3), said primary support frame (9) preferably comprising a primary housing seat (6) destined to receive the primary return element (4) and yet more preferably comprising a protection surface (9b) substantially oriented towards the external environment and connected to said primary housing seat (6).

23. Fitting as claimed in claim 19, further comprising a secondary support frame (10) integrally connected to the fixed part (3b) of the fitting (3), said secondary support frame (10) being preferably connected to the corresponding floor portion positioned at the ground level and in proximity to the movable part (3a) of the fitting (3).

24. Fitting as claimed in claim 23, wherein said secondary support frame (10) comprises an outer portion (10a) destined to be oriented at least partially towards the external environment under operative conditions and an inner portion (10b) connected to said outer portion (10a) and having an abutment portion (11) destined to be engaged at least partially by the movable part (3a) of the fitting (3) when the sealing body (2) is in the closed position.

25. Fitting as claimed in claim 24, wherein said secondary housing seat (7) is integrally obtained in said outer portion (10a) of the secondary support frame (10).

26. Fitting as claimed in claim 19, further comprising a heat cut-off element (11) operatively interposed between the inner portion (10b) and the outer portion (10a) to prevent a heat flow from and/or to the external environment.

27. Threshold for entrance spaces in buildings, comprising, at least in correspondence with a side defined or operatively associated with a floor portion, a gasket (1) as claimed in claim 1.
